(19) United States
(12) Patent Application Publication
(10) Pub. No.: US 2008/0253579 A1
(43) Pub. Date: Oct. 16, 2008

(54) At-Home Hearing Aid Testing and Clearing System

(75) Inventors: John Cronin, Jericho, VT (US); Tushar Narsana, Naperville, IL (US); Mark Burrows, Princeton, NJ (US)

Correspondence Address: MCCARTER & ENGLISH, LLP, FOUR GATEWAY CENTER, 100 MULBERRY STREET, NEWARK, NJ, 07102, US

(73) Assignee: Johnson & Johnson Consumer Companies, Inc., Skillman, NJ (US)

(21) Appl. No.: 11/570,453

(22) PCT Filed: Jun. 10, 2005
(86) PCT No.: PCT/US2005/020438

§ 371 Date: Jun. 11, 2008

Related U.S. Application Data
(60) Provisional application No. 60/579,479, filed on Jun. 14, 2004.
(60) Provisional application No. 60/579,220, filed on Jun. 14, 2004.

(51) Int. Cl. H04R 29/00

(52) U.S. Cl. 381/60

(57) ABSTRACT

The present invention is an apparatus for and method of remotely, automatically, and routinely conducting diagnostic testing on a programmable hearing aid to ensure that it is functioning as intended when optimized for an individual's needs and preferences. Because hearing aids deteriorate with time and buildup of earwax, individuals can be uncertain whether their hearing is worsening or the hearing aid is malfunctioning. The net effect is diminished hearing aid performance and thus diminished quality of life. The present invention tests the hearing aid for proper function as frequently as daily. Additionally, the present invention includes elements (201, 202) that enable the apparatus to perform a cleaning process to effectively remove earwax and other undesirable debris from the hearing aid. The cleaning process can occur prior to the diagnostic testing or as a result of the diagnostic testing.

### CROSS REFERENCE TO RELATED APPLICATION

This application claims the benefit of U.S. Provisional Application Nos. 60/579,479 filed Jun. 14, 2004 and 60/579,220 filed Jun. 14, 2004, assigned to the assignee of this application and incorporated by reference herein.

### FIELD OF THE INVENTION

The present invention relates to hearing aids, specifically to a method of and apparatus for automatically testing an individual's hearing aid in the individual's home as frequently as daily in order to determine whether the hearing aid needs to be cleaned or serviced and performing the cleaning process if deemed necessary.

### BACKGROUND OF THE INVENTION

About two million hearing aids are sold annually in the U.S., generating $2.6 billion in revenue. Although 28 million Americans are hearing impaired, only six million use hearing aids. Year after year, market penetration has increased little, making it apparent that factors other than user need have inhibited market penetration of hearing aids. Central among these factors is the product-centric (as opposed to patient-centric) approach that the hearing aid industry has taken to fitting hearing aids. Hearing aid manufacturers concentrate efforts almost solely on improving their devices, most notably with digital signal processing's (DSP), while other patient needs and preferences are virtually ignored. Resources have not gone to improving the consequently ponderous process which patients face in purchasing, using, and maintaining a hearing aid.

The anatomy of the ear canal includes ceruminous glands that secrete a yellowish, wax-like substance called cerumen (earwax), which accumulates in the ear canal. Due to both the action of cilia located in the ear canal and the natural movements of the ear canal, the cerumen gradually migrates outward. When a hearing aid is inserted into the ear canal, it is susceptible to the effects of cerumen accumulation and migration. Cerumen often mixes with sloughed off skin and dirt, further impairing the performance of the hearing aid.

Acoustic speakers in most modern hearing aids are particularly susceptible to performance problems and damage from cerumen accumulation; initially, cerumen blocks the speaker port, occluding the acoustic path, in turn preventing sound waves from reaching the tympanic membrane. Eventually, the cerumen can penetrate the receiver housing, damaging the sensitive mechanical and electrical components whose failure necessitates repair or replacement of the hearing aid. Not only is the cost in time and money significant, but also individuals are uncertain whether their hearing is worsening or the hearing aid is malfunctioning. The net effect is diminished hearing-aid performance—and thus a diminished quality of life.

U.S. Pat. No. 6,349,790, entitled, “Self-cleaning cerumen guard for a hearing device,” assigned to Sonic Innovations and incorporated by reference herein, describes a thermally activated cleaning element on the distal end of a hearing aid adjacent to the speaker, which retracts when heated by the inner ear to body temperature, then extends when cooled to room temperature. Upon removal of the hearing aid from the ear, the self-cleaning cerumen guard automatically removes any debris that has accumulated in the speaker port.

U.S. Pat. No. 5,401,920, entitled, “Cerumen filter for hearing aids,” and incorporated by reference herein, discloses a replaceable and disposable wax guard that is affixed over the sound port of an in-the-ear hearing aid by means of a pressure-sensitive tape. The filter itself is porous to sounds but is receptive to cerumen. While providing some level of protection against cerumen damage to the internal components of the hearing device, this and other similar types of filters become quickly soiled, resulting in poor device performance due to a blocked speaker port. As such, the user must frequently replace the disposable filter. The small size of these devices often requires a high level of visual acuity and dexterity for such maintenance.

U.S. Pat. No. 5,327,500, entitled, “Cerumen barrier for custom in the ear type hearing instruments,” and incorporated by reference herein, discloses a cerumen barrier for a custom, in-the-ear hearing aid. The cerumen barrier consists of a small door covering the receiver port that can be manually rotated open to provide cleaning under the door and around the receiver port. While also providing some level of protection against cerumen to the internal components of the hearing aid, significant user intervention is needed to clean the filter.

With the exception of the '790, the hearing aid devices from the prior art have a profound shortcoming of relying upon the hearing aid user to remember to periodically clear the cerumen that has accumulated on the device. Yet hearing aid users are no different from consumers of other products: all want convenience. Cleaning a hearing aid is one more thing to remember, so it is not done faithfully. This issue has become even more important as hearing aids have gotten smaller. Primarily to overcome the stigma of wearing a hearing aid, manufacturers have miniaturized hearing aids to the point that completely-in-canal (CIC) hearing aids reside out of sight deep in the ear canal, proximate to the tympanic membrane (eardrum). This placement provides the overriding benefits of improving frequency response, reducing distortion due to jaw extrusion, and improving overall sound fidelity; however, it worsens the problem of earwax buildup.

When users are unsure of or unhappy with their hearing aid's performance, they must bear the inconvenience and cost of taking it to their audiologist for assessment and adjustment. There is currently no way for users to test and calibrate their hearing aids to manufacturers' standards, ensuring optimal hearing aid performance, from the convenience of their homes. Moreover, no automatic tests, i.e., tests that do not require the hearing aid users' manual intervention, exist today.

U.S. Pat. No. 6,379,314, entitled, “Internet system for testing hearing,” assigned to Health Performance, Inc. and incorporated by reference herein, relates to a computer system that is accessible to a community of users for self-administered hearing tests over the Internet, which is a significant improvement to conventional hearing testing that requires sophisticated equipment at dedicated hearing and health centers by experienced personnel. Such automatic audiometers are becoming widely accepted in hearing screening applications such as in schools and industrial clinics. This automated approach results in minimal operator involvement, faster testing, and improved accuracy.

U.S. Pat. No. 4,284,847, entitled, “Audiometric testing, analyzing, and recording apparatus and method,” and incorporated by reference herein, discloses a microprocessor-based audiometry apparatus that includes a means of generating tones at variable frequency and intensities, memory for software, and patient data storage. The apparatus is capable of being networked with remote computers for data transfer. One of the main features of the '847 patent is its ability to compare recent audiogram data with previously acquired data, and then automatically compute such changes as hearing threshold shifts.

U.S. Pat. No. 6,411,678, entitled, “Internet based remote diagnostic system,” assigned to General Electric Company and incorporated by reference herein, discloses a remote diagnostic communication system that uses a public or private remote access infrastructure to facilitate wide-area communications between the remote site and the diagnostic center and that requires only local telephone calls. The diagnostic center and one or more remote sites at which monitored equipment is located are coupled to a wide area network (WAN). When data is to be transferred from a remote site to the central diagnostic center, the remote site initiates a local telephone call to a point-of-presence (POP) server on the WAN backbone. This could be an Internet service provider (ISP) in the case of the Internet, or an intranet POP server in the case of a private network. Data is then transferred to a computer in the POP server or anywhere on the network, as long as it is outside the “firewall” electronically isolating the diagnostic center from unwanted communications. To complete the transfer, the diagnostic center transfers the data from the POP server to the diagnostic center via the public or private wide-area network (the Internet or an intranet). The data transfer can take place either on a scheduled basis, or when an alarm condition is detected at the remote site. The central diagnostic center can prompt the remote site to connect to the POP server via a wireless paging service or a direct-dial phone call.

The '314 patent demonstrates a means for conducting automatic hearing tests over the Internet while the '678 patent discloses remote diagnostic testing of electronic equipment over the Internet, either on demand or as scheduled. The prior art, however, does not combine these means in a manner that provides a remote diagnostic test for hearing aids, much less an automated test, that does not rely on the faithful and concerted efforts of patients. Further, the prior art does not provide a means for an automatic cleaning process to be initiated in response to such diagnostics.

### SUMMARY OF THE INVENTION

It is therefore an object of the present invention to simplify the process of diagnostic testing and maintaining hearing aids, so that the hearing aid testing can be done in a more convenient location for the user, such as the user's home.

It is another object of the present invention to provide automatic, convenient, at-home remote diagnostic testing of a hearing aid that can be performed as frequently as daily and that can signal hearing aid status updates, such as improper functioning or the need for service.

It is yet another object of the invention to provide automatic cleaning functionality in response to or in addition to the above-mentioned automatic diagnostic tests.

The present invention is an at-home hearing aid testing and cleaning apparatus and a method of operating the testing and cleaning apparatus, which can be performed as frequently as daily. An individual places the hearing aid in a small countertop device at regular intervals, such as at the end of each day; the device tests the audio frequency range for which the hearing aid is designed and for which the device is soundproof. The device tests the hearing aid for proper function by pinging it with a series of audio waves, after which the device signals the individual as appropriate of such status as improper function, service required, etc. Additionally, the apparatus may be connected via Internet or other network connectivity to a central computer that remotely further diagnoses the hearing aid. The device may also issue a series of corrective tones (if the hearing aid is programmable) to provide some degree of servicing, for instance, adding amplification in response to the hearing aid's normal degradation over time. This networking capability also enables continuous updating of an individual's file on the central computer for reference and analysis by audiologists and other stakeholders to find ways to continually improve the individual's hearing. Additionally, the hearing aid testing and cleaning apparatus initiates a cleaning process that effectively removes earwax and other undesirable buildup from the hearing aid device. The cleaning process can be performed prior to the diagnostic testing or in response to the diagnostic testing (i.e., only when needed.) Further, the cleaning process can be performed iteratively.

Thus, the present invention provides for a portable hearing aid cleaning and testing apparatus comprising:

a resealable housing defining a cavity for receiving a hearing aid, wherein the cavity includes a microphone and has a configuration for securing the hearing aid in a position where a speaker of the hearing aid is opposite of the microphone;

means for cleaning the hearing aid when the hearing aid is received within the cavity and the housing is in a sealed condition;

communications interface means for coupling to a data signal connection means of the hearing aid; and

a controller coupled to the communications interface means, the microphone and an indicia output means (e.g., indicator light), wherein the controller is operable to perform at least one of a cleaning and a testing of operation of the hearing aid.

In a preferred embodiment, the means for cleaning includes at least one of a means for filling and emptying the cavity with a cleaning fluid, a means for heating the cavity, a means for heating the cleaning fluid and a means for agitating the fluid when the fluid is in the cavity.

In a further preferred embodiment, the testing of operation of the hearing aid by the controller comprises:

transmitting testing data from the controller (e.g., directly to the hearing aid or to a speaker within the cavity) to cause the hearing aid to generate sound output;

receiving the hearing aid sound output at the microphone and forwarding sound data signals representative of the sound output to the controller;

evaluating the sound signals to determine whether frequencies and amplitudes of the sound signals correspond to respective expected frequencies and amplitudes associated with the testing data; and

generating a selected indicia (e.g., pass, fail, clean hearing aid) for output at the indicia output means based on the evaluation.

In a further preferred embodiment, the testing of operation of the hearing aid includes:

downloading hearing aid programming from the hearing aid to the controller;

writing testing data (such as user customized testing data) to a memory in the hearing aid;

causing testing sound output to be generated at an external speaker output of the apparatus;

receiving at the microphone hearing aid sound output resulting from operation of the testing data;

forwarding sound data signals representative of the sound output to the controller;

evaluating the sound signals to determine whether frequencies and amplitudes of the sound signals correspond to respective expected frequencies and amplitudes associated with the testing data; and

generating a selected indicia (e.g., pass, fail, clean hearing aid) for output at the indicia output means based on the evaluation.

### BRIEF DESCRIPTION OF THE DRAWINGS

FIG. 1A is a block diagram illustrating the basic operation of a hearing aid that is programmable by a serial interface.

FIG. 1B is a block diagram illustrating a serial interface for programming a hearing aid.

FIG. 2 is a device for in-home, routine, automatic diagnostic testing and cleaning of a hearing aid.

FIG. 3 is an alternate embodiment of a device for in-home, routine, automatic diagnostic testing and cleaning of a hearing aid.

FIG. 4 is a method of conducting a routine automatic diagnostic test using the apparatus of the present invention with tones and other test data generated by the tester.

FIG. 5 is a method of conducting a routine automatic diagnostic test using the apparatus of the present invention with tones and other test data generated by the hearing aid.

FIG. 6 is a method of cleaning the hearing aid after diagnostic testing using the apparatus of the present invention.

FIG. 7 is a method of cleaning the hearing aid after diagnostic testing using the alternate embodiment of the apparatus of the present invention.

FIG. 8 is a block diagram of the interface between an in-home, routine, diagnostic testing and cleaning apparatus and a hearing aid.

### DESCRIPTION OF THE INVENTION

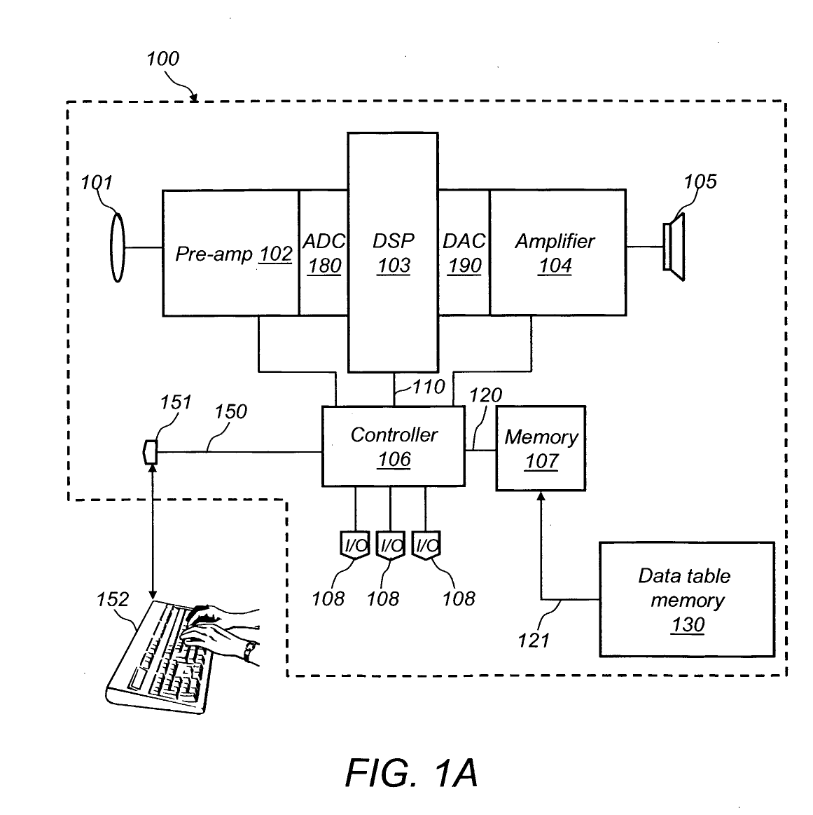

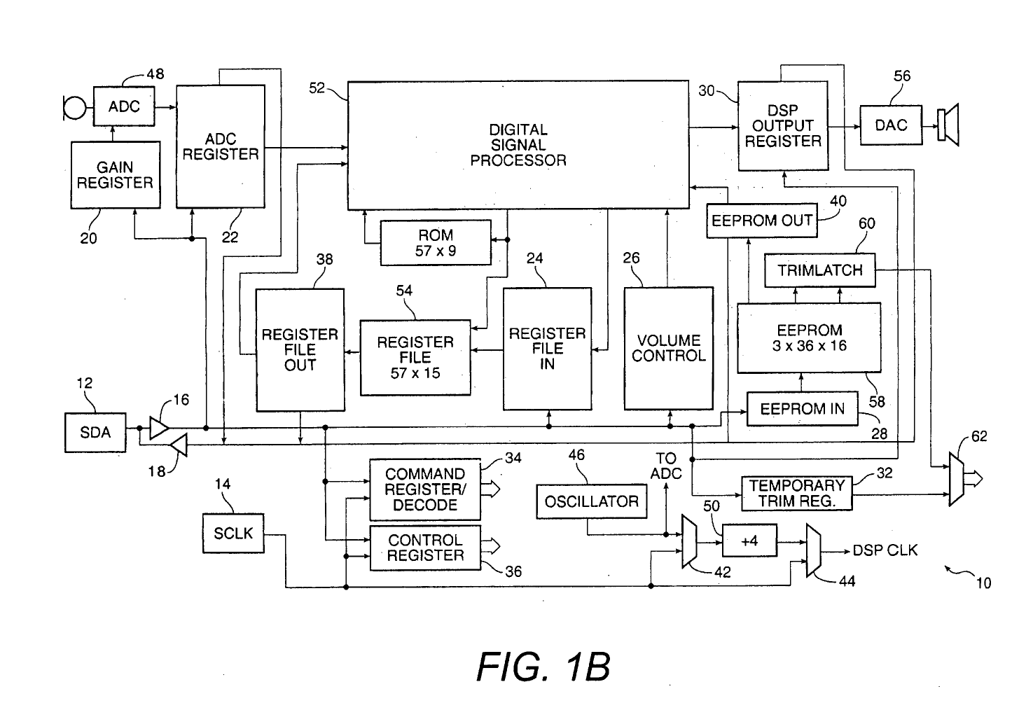

FIG. 1A is a block diagram illustrating the components of a basic prior art hearing aid 100, and basic operation of a programmable hearing aid, which is programmable by a serial interface in order to be optimized for an individual patient's hearing needs and preferences.

Hearing aid 100 includes the following conventional components: a microphone 101, a pre-amplifier (pre-amp) 102, an analog-to-digital converter (ADC) 180, a digital signal processor (DSP) 103, a digital-to-analog converter (DAC) 190, an amplifier 104, an output speaker 105, a data table memory 130, an address and data bus 121, a memory 107, a controller 106, an address and data bus 120, an address and data bus 110, a plurality of input/output devices (I/O) 108, a programming connection 150, and a socket connector 151.

With hearing aid 100 in a user's ear, sound is collected as an analog signal in microphone 101. This signal is amplified using pre-amp 102, is converted from analog to digital in ADC 180, and then is processed by DSP 103 to meet the individual's unique requirements. The signal from DSP 103 is then converted from digital to analog using DAC 190. This analog signal is then amplified using amplifier 104 for transmission to output speaker 105.

A means of programming DSP 103 in order to optimize basic hearing aid 100 for an individual is described, for example, in U.S. Pat. No. 6,201,875, entitled, “Hearing aid fitting system,” assigned to Sonic Innovations, Inc and incorporated by reference herein. Programming DSP 103 requires that an individual's specific hearing compensation requirements data, like amplitude versus frequency, be loaded from data table memory 130 via address and data bus 121 to memory 107 (such as an EEPROM). Controller 106 then accesses memory 107 via address and data bus 120 to load the hearing compensation requirements data onto DSP 103 via address and data bus 110. I/O 108, such as on/off, volume, and squelch, connected to controller 106 provide individuals with a degree of external control of hearing aid 100.

Referring again to FIG. 1A, computer 152 is an external circuit that can be used to program basic hearing aid 100 via socket connector 151, which allows for external communication, and programming connection 150, which allows for a serial or parallel input. U.S. Pat. No. 6,319,020, entitled, “Programming connector for hearing devices,” assigned to Sonic Innovations, Inc. and incorporated by reference herein, further describes the connections of a programmable hearing aid device. Building a serial interface for programming a hearing aid is also described in U.S. Pat. No. 6,240,193, entitled, “Two-line variable word length serial interface,” assigned to Sonic Innovations, Inc. and incorporate by reference herein, and is briefly described below in FIG. 1B.

In operation, controller 106 gets programmed data from data table memory 130 and loads it into memory 107. The programmed data is then used by DSP 103 when signals go through microphone 101 and pre-amp 102 to ADC 180. After DSP 103 operates on the input signal, DSP 103 outputs the modified and processed signal to DAC 190 and then to amplifier 104 to output speaker 105 of hearing aid 100. Controller 106 uses address and data buses 110, 120 and 121 to move data from DSP 103 as needed. Controller 106 also provides connection to I/O 108 on/off, volume, or squelch external adjusters. In addition, controller 106 connects to programming connection 150, in which socket connector 151 allows communication with an external circuit, such as computer 152, allowing a user to program or direct controller 106.

FIG. 1B illustrates a prior art serial interface for programming a hearing aid, as described in the '193 patent. FIG. 1B is a block diagram of a digital programmable hearing aid 10 (e.g., basic hearing aid 100 of FIG. 1A), including the serial interface. In the serial interface circuit, an SDA pin 12 and an SCLK pin 14 are depicted, while the pins for power and ground are omitted for simplicity's sake. SDA pin 12 is connected to the input of an input buffer 16, and to the output of an output buffer 18. Input buffer 16 is connected to a gain register 20, an ADC register 22, a register file input buffer register 24, a volume control register 26, an EEPROM input buffer register 28, a DSP output register 30, a temporary trim register 32, a command register 34, and a control register 36. Control register 36 includes a latch (not shown). Output buffer 18 is connected to ADC register 22, a register file output buffer register 38, an EEPROM output buffer register 40, and DSP output register 30.

SCLK pin 14 is connected to command register 34, control register 36, a first two-input multiplexer 42, and a second two-input multiplexer 44. An internal oscillator 46 is connected to a second input of first two-input multiplexer 42 and also provides a clock to an ADC 48 (i.e., ADC 180 of FIG. 1A). During normal operation of hearing aid 10, the input of ADC 48 is connected to the electrical input to hearing aid 10. The output of ADC 48 is connected to ADC register 22. The output of first two-input multiplexer 42 is connected to the input of a divide-by-four circuit 50. The output of divide-by-four circuit 50 is connected to the second input of second two-input multiplexer 44. The output of second two-input multiplexer 44 provides a clock to a DSP 52 (i.e., DSP 103 of FIG. 1A).

The output of register file input buffer register 24 is connected to a register file 54, and the output of register file 54 is connected to the input of register file output buffer register 38. The output of DSP output register 30 is connected to a DAC 56 (i.e., DAC 190 of FIG. 1A). The output of EEPROM input buffer register 28 is connected to an EEPROM 58, and the output of EEPROM 58 is connected to the input of EEPROM output buffer register 40 and a trim latch 60. The output of trim latch 60 is connected to a third two-input multiplexer 62, and the second input of third two-input multiplexer 62 is connected to the output of temporary trim register 32. The output of third two-input multiplexer 62 provides trim signals to various circuits in hearing aid 10.

In the serial interface, SDA pin 12 is employed to input a serial data stream including various read and write instructions (described below) from the HI-PRO or external device to hearing aid 10 and to output data from hearing aid 10 both during testing and in the fitting process to determine whether the data in hearing aid 10 is as expected. SCLK pin 14 is used to input a serial clock that clocks in the instructions from the serial data input stream on SDA pin 12.

The present maximum clock rate from the HI-PRO device to the serial interface circuit is 7 kHz. It is anticipated, however, that the serial interface circuit will also interface to other devices such as IC testers, and as a result, the SDA and SCLK signals can operate at 1.5 MHz when receiving data from an external source. The serial interface circuit can drive output through SDA pin 12 having a 50-pf load at a 500 kHz clock rate.

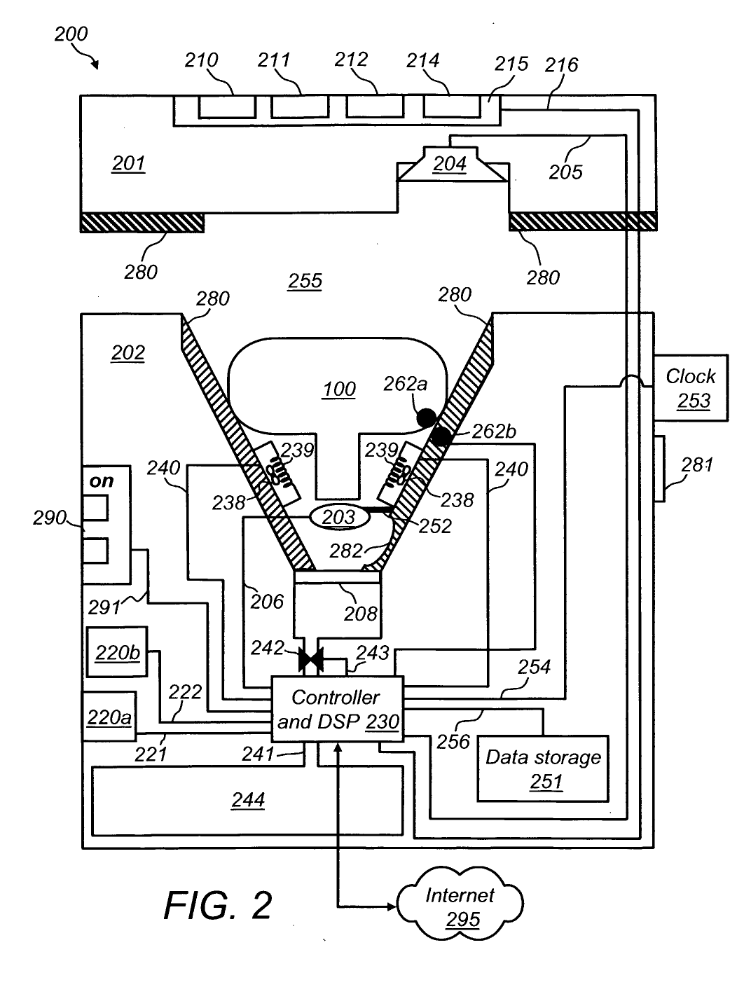

FIG. 2 is a testing and cleaning device 200, in accordance with the present invention, for at-home routine automatic diagnostic testing of a hearing aid, such as basic hearing aid 100 of FIG. 1A, which is vacuum sealed within a cavity 255 of testing and cleaning device 200. Testing and cleaning device 200 is composed of a top 201 and a base 202 that, upon contact, form fluid-tight cavity 255. Included in base 202 is a microphone 203 that captures test tones processed by hearing aid 100 and sends the tones via a connection 206 to a controller and DSP 230. Controller and DSP 230 sends test tones via a speaker connection 205 to a speaker 204, which plays the tones so that they are received by microphone 101 of basic hearing aid 100.

Information obtained from testing is stored in a data storage unit such as a data storage 251, which is connected to controller and DSP 230 via a connector 256. Data storage 251 contains pertinent data such as a user profile, battery life and longevity, and number of cleanings, which an audiologist will find useful in making determinations such as the condition of hearing aid 100. In an alternate embodiment, data contained in data storage 251 can be transmitted to an audiologist via the Internet 295, providing additional speed and comfort for the consumer. Internet 295 represents the capability to connect to the Internet, an intranet, or other similar network in order to download test programs, ANSI calibration standards, and the like, and to upload test results to a central database for reference and analysis of patient files.

A plurality of indicator lights 210, 211, 212, and 214 in a light panel 215 are connected by a connector 216 to controller and DSP 230 and signal such messages as “Power on,” “Service hearing aid,” “Cleaning cycle in progress,” “Passed test,” etc., as appropriate to the diagnostic test results. Either a means for AC power 220a or a means for DC power 220b is connected to testing and cleaning device 200 by either a connection 221 or a connection 222, respectively.

An on/off switch 290 is used to turn testing and cleaning device 200 on and off, sending a signal through a connector 291 to controller and DSP 230.

A serial connector 262a within hearing aid 100 connects hearing aid 100 to a serial connector 262b on testing and cleaning device 200 for diagnostic testing. A quantity of soundproofing 280 is provided to ensure sound tightness, preventing ambient noise from interfering with diagnostic testing.

Once testing is finished and before the cleansing process of hearing aid 100 begins, DSP and controller 230 lowers microphone 203 by means of a hinge 252 to reside in a groove 282.

A duality of heating devices, each including a heating element 239 and a fan 238, are located near base 202, close to the speaker 105 ends of hearing aid 100. Heating element 239 is a conventional heat emission device such as an electric heating coil or an UV light source. Fan 238 can be a conventional air-circulating fan. Heating elements 239 and fans 238 are controlled by controller and DSP 230 via a duality of connectors 240 and serve to draw out moisture from earwax accumulated on hearing aid 100. The earwax is then desiccated and sucked away by a vacuum 208 into a length of tubing 241 controlled by a valve 242. Valve 242 is connected to and controlled by controller and DSP 230 through a connector 243. Vacuum 208 also pulls hearing aid 100 snugly into soundproofing 280 of base 202 to ensure a soundproof environment for output speaker 105 of hearing aid 100 and microphone 203. Dried earwax particulate accumulates in a reservoir 244, which can later be emptied by the user. Alternately, reservoir 244 can be eliminated from testing and cleaning device 200 by connecting cavity 255 directly to the exterior of testing and cleaning device 200 via tubing 241 and valve 242.

It is assumed that all elements of hearing aid 100 and testing and cleaning device 200 that are exposed to heating element 239 are capable of withstanding repeated and prolonged exposure to a sustained heat source. In a preferred embodiment, the hearing aid 100 and the device 200 include a layer of material having low heat energy absorption characteristics on all surfaces exposed to the external environment.

Clock 253 is a conventional display clock, for example, a liquid crystal display (LCD) clock of a clock-radio alarm. Clock 253 is connected to and controlled by controller and DSP 230 through a connection 254. Clock 253 can be located at the side of testing and cleaning device 200 to show the time and to make the user more likely to place testing and cleaning device 200 in an accessible location such as a nightstand. The placement of testing and cleaning device 200 in an area of common and plain view would serve to continually remind the user of the necessity of regularly cleaning hearing aid 100.

A product prescription ID 281 is a conventional identification label or tag located on the side of testing and cleaning device 200. Product prescription ID 281 displays the user's hearing aid prescription. Product prescription ID 281 can be used by a professional, such as an audiologist, to compare the user's original hearing aid prescription with the actual functioning of hearing aid 100 after testing and cleaning of hearing aid 100 has been completed. The audiologist can therefore determine the accuracy of the functioning of hearing aid 100.

In operation, top 201 is opened; hearing aid 100 (which has DSP 103 preprogrammed based upon a hearing test at the audiologist) is powered on and fitted in base 202, positioned above microphone 203. Testing and cleaning device 200 is closed and vacuum 208 sucks hearing aid 100 in tightly to ensure that hearing aid 100 fits snugly in cavity 255. Soundproofing 280 ensures that testing and cleaning device 200 is soundproofed and groove 282 holds microphone 203 in its resting position.

On/off switch 290 is used to turn testing and cleaning device 200 on and includes an indicator that indicates that testing and cleaning device 200 is switched on.

Controller and DSP 230 controls the entire electronic operation of testing and cleaning device 200. Controller and DSP 230 has been loaded with information about the user's specific hearing test results so that it may uniquely test that user's hearing aid 100. Controller and DSP 230 draws power from either AC power 220a or DC power 220b.

Controller and DSP 230 may download current data and programs from a remote location via Internet 295. Controller and DSP 230 can program hearing aid 100 through serial connector 262a, which connects hearing aid 100 to serial connector 262b on testing and cleaning device 200 for diagnostic testing. Controller and DSP 230 can erase and rewrite data table memory 130 of hearing aid 100 of FIG. 1A.

Controller and DSP 230 run programs that determine what data is written to data storage 251 in order to program hearing aid 100. Then controller and DSP 230 sends audio test sounds to speaker 204 using speaker connection 205. Hearing aid 100, via its DSP 103, processes the test sounds and emits them from its own output speaker 105. These sounds are received by microphone 203 and are sent through connection 206 back to controller and DSP 230. The testing process continues as controller and DSP 230 sends out its entire series of test sounds and receives the entire series back. Controller and DSP 230 compares the actual test results with the expected test results, and diagnoses the status of hearing aid 100. This status is sent to light panel 215 through connector 216, and indicator lights 210, 211, 212 and 214 provide messages such as “Power on,” “Cleaning cycle in progress,” “Service hearing aid,” and “Passed test,” as appropriate to the test results. Controller and DSP 230 can also download data regarding battery drain, changes in user profile, and general performance to data storage 251 for future reference.

It should be noted that a program to debug testing and cleaning device 200 could be run without hearing aid 100 in testing and cleaning device 200 to ensure that testing and cleaning device 200 is working properly.

Additionally, testing and cleaning device 200 performs a cleaning process to eliminate earwax and other undesirable buildup from hearing aid 100. The cleaning process may be performed prior to the testing process described above or subsequent to the testing process described above (i.e., as a result of the testing process determining the need for hearing aid 100 to be cleaned), and may further be performed iteratively.

In the cleaning process, controller and DSP 230 activates heating elements 239 and fans 238 through connectors 240. Heating elements 239 emit heat, which is circulated around hearing aid 100 by fans 238. The heat from heating elements 239 desiccates and kills foreign residue, such as earwax and bacteria, on hearing aid 100 by drawing moisture away from the foreign residue. The air moved by fans 238 further helps peel off the dried residue, which is then sucked away from hearing aid 100 by vacuum 208. Electrical signals from controller and DSP 230 via connector 243 actuate valve 242 to open. Particles are sucked, by vacuum 208, through valve 242 and accumulate in optional reservoir 244, which can later be emptied. Upon completion of the cleaning process, controller and DSP 230 turns off heating elements 239 and fans 238 via connectors 240 and turns off and vacuum 208 via connection 206.

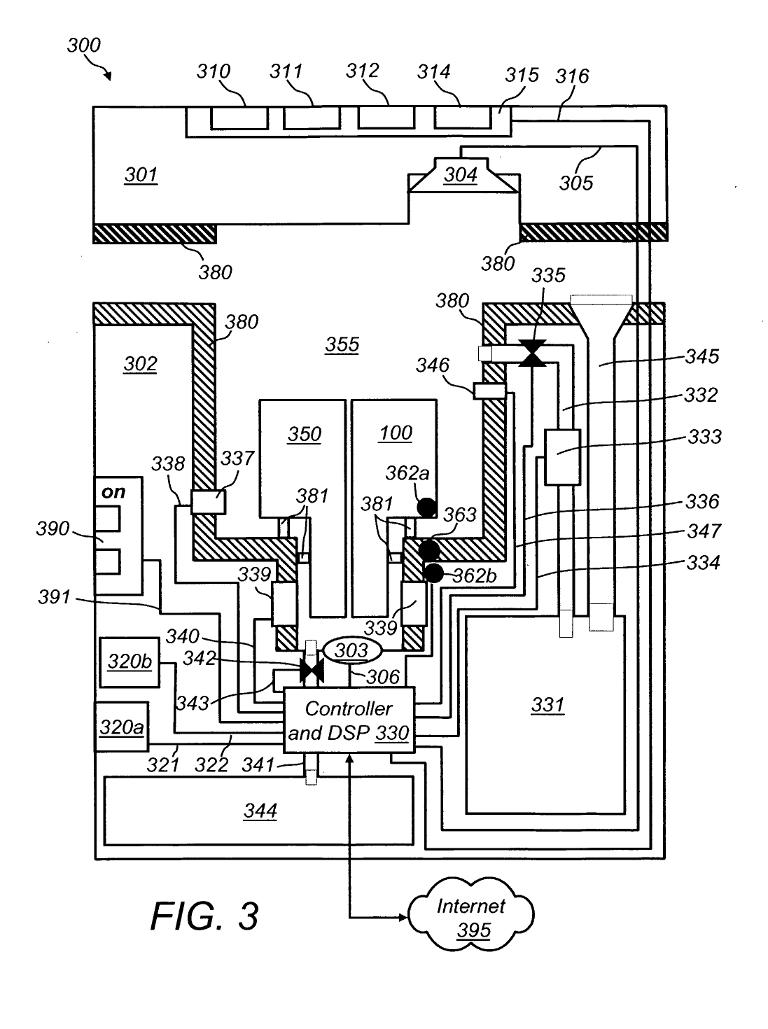

FIG. 3 is an alternate testing and cleaning device 300 for at-home routine automatic diagnostic testing of a hearing aid, such as basic hearing aid 100 of FIG. 1A. Testing and cleaning device 300 is composed of a top 301 and a base 302 that, upon contact, form a fluid-tight cavity 355. Included in base 302 is a microphone 303 that captures test tones processed by hearing aid 100 and sends the tones via a connection 306 to a controller and DSP 330. Controller and DSP 330 sends test tones via a speaker connection 305 to a speaker 304, which plays the tones so that they are received by microphone 101 of basic hearing aid 100.

A plurality of indicator lights 310, 311, 312, and 314 in a light panel 315 are connected by a connector 316 to controller and DSP 330 and signal such messages as “Power on,” “Service hearing aid,” “Cleaning cycle in progress,” “Passed test,” etc., as appropriate to the diagnostic test results. Either a means for AC power 320a or a means for DC power 320b is connected to testing and cleaning device 300 by either a connection 321 or a connection 322, respectively.

An on/off switch 390 is used to turn testing and cleaning device 300 on and off, sending a signal through a connector 391 to controller and DSP 330. An adapter 350 may be used to ensure the proper physical fit of hearing aid 100 in proximity to microphone 303.

A serial connector 362a within hearing aid 100 connects hearing aid 100 to a serial connector 362b on testing and cleaning device 300 for diagnostic testing. An optional adapter serial connector 363 connects serial connectors 362a and 362b when optional adapter 350 is used. A quantity of soundproofing 380 is provided to ensure sound tightness, preventing ambient noise from interfering with diagnostic testing. A plurality of spacers 381 are disposed at appropriate locations on the outer surface of soundproofing 380 to optimally position hearing aid 100 with respect to microphone 303 while permitting cleaning solution to make contact with hearing aid 100 on all sides, including the bottom surface of hearing aid 100, upon which earwax most heavily accumulates. Spacers 381 can simply be an appropriately textured outer surface of soundproofing 380, such as a series of bumps or ridges or a helical groove much like that which could house a screw, or, alternately, can be hollow annular forms fixedly attached to soundproofing 380.

A reservoir 331, used for housing cleaning solution such as hydrogen peroxide or another formulation for dissolving earwax, is manually filled by the user through an inlet shaft 345. Reservoir 331 supplies cavity 355 during the cleaning cycle via a length of tubing 332. A small pump 333 and a valve 335 that are controlled by controller and DSP 330 via a connector 334 and a connector 336, respectively, facilitate transport of cleaning solution from reservoir 331 to cavity 355 upon command from controller and DSP 330.

A sensing element 346 senses the level of cleaning solution within cavity 355 as cleaning solution is introduced into cavity 355 and communicates the sensed level of cleaning solution to controller and DSP 330 via a connector 347.

A heater, such as a resistive heating element 339, that is controlled by controller and DSP 330 via a connector 340 serves to increase the temperature of the cleaning solution once the cleaning solution is introduced to cavity 355 and the cleaning cycle begins.

An agitator 337, such as a piezoelectric or ultrasonic vibrating mechanism, that is controlled by controller and DSP 330 via a connector 338 serves to provide turbulence to the cleaning solution once the cleaning solution is introduced to cavity 355 and the cleaning cycle begins.

A reservoir 344 for draining and temporarily housing used cleaning solution is supplied by cavity 355 via a length of tubing 341 upon completion of the cleaning cycle. A valve 342 that is controlled by controller and DSP 330 via a connector 343 is disposed at an appropriate location along the length of tubing 341 to facilitate withdrawal of used cleaning solution from cavity 355 upon command by controller and DSP 330 upon completion of the cleaning cycle. An additional pump (not shown) can optionally be disposed in tubing 341 to better facilitate purging of used cleaning solution. An additional length of tubing (not shown) and a valve (not shown) can serve to purge reservoir 344 upon the appropriate mechanical actions of the user (e.g., the user removes a small gasket from the bottom of testing and cleaning device 300 or rotates a small dial) or electrical signals from controller and DSP 330. Alternately, reservoir 344 can be eliminated from testing and cleaning device 300 by connecting cavity 355 directly to the exterior of testing and cleaning device 300 via tubing 341 and valve 342. In such a case, valve 342 is likely to be manually actuated or replaced by a gasket.

The Internet 395 represents the capability of controller and DSP 330 to connect to the Internet, an intranet, or other similar network, in order to download test programs, ANSI calibration standards, and the like, and to upload test results to a central database for reference and analysis of patient files.

It is assumed that all elements of hearing aid 100 and testing and cleaning device 300 that are to come in to contact with cleaning solution are capable of withstanding repeated and prolonged exposure to cleaning solution.

It should be noted that elements top 201, base 202, microphone 203, speaker 204, speaker connection 205, connection 206, indicator light 210, indicator light 211, indicator light 212, indicator light 214, light panel 215, connector 216, AC power 220a, DC power 220b, connection 221, connection 222, controller and DSP 230, tubing 241, valve 242, connector 243, reservoir 244, cavity 255, serial connector 262a, serial connector 262b, soundproofing 280, on/off switch 290, connector 291, and Internet 295 of FIG. 2 share the same functionality as top 301, base 302, microphone 303, speaker 304, speaker connection 305, connection 306, indicator light 310, indicator light 311, indicator light 312, indicator light 314, light panel 315, connector 316, AC power 320a, DC power 320b, connection 321, connection 322, controller and DSP 330, tubing 341, valve 342, connector 343, reservoir 344, cavity 355, serial connector 362a, serial connector 362b, soundproofing 380, on/off switch 390, connector 391, and Internet 395, respectively, of FIG. 3.

In operation, top 301 is opened and hearing aid 100 (which has DSP 103 preprogrammed based upon a hearing test at the audiologist) is powered on and fit in base 302, positioned above microphone 303 (optionally using adapter 350, which provides the ability to fit many different sizes of hearing aids 100 in standard sized testing and cleaning device 300). Testing and cleaning device 300 is closed and soundproofing 380 ensures that testing and cleaning device 300 is soundproofed.

In a preferred embodiment, the soundproofing 380 of the base 302 of the device 300 includes inner and outer surfaces. The inner surface is opposite the cavity 355 and is compatible with the internal construction of the base 302 and its elements. The outer surface has a construction customized to the outer surface configuration of a predetermined hearing aid, such that the hearing aid is held securely and snugly within the cavity 355.

On/off switch 390 is used to turn testing and cleaning device 300 on and includes an indicator that indicates that testing and cleaning device 300 is switched on.

Controller and DSP 330 controls the entire electronic operation of testing and cleaning device 300. Controller and DSP 330 has been loaded with information about the user's specific hearing test results so that it may uniquely test that user's hearing aid 100. Controller and DSP 330 draws power from either AC power 320a or DC power 320b.

Controller and DSP 330 may download current data and programs from a remote location via Internet 395. Controller and DSP 330 can program hearing aid 100 through serial connector 362a; which connects hearing aid 100 to serial connector 362b on testing and cleaning device 300 for diagnostic testing. Optional adapter serial connector 363 connects serial connectors 362a and 362b when optional adapter 350 is used. Controller and DSP 330 can erase and rewrite data table memory 130 of hearing aid 100 of FIG. 1A.

Controller and DSP 330 runs programs that determine what data is written to data table memory 130 in order to program hearing aid 100. Then controller and DSP 330 sends audio test sounds to speaker 304 using speaker connection 305. Hearing aid 100, via its DSP 103, processes the test sounds and emits them from its own output speaker 105. These sounds are received by microphone 303 and are sent through connection 306 back to controller and DSP 330. The testing process continues as controller and DSP 330 sends out its entire series of test sounds and receives the entire series back. Controller and DSP 330 compares the actual test results with the expected test results, and diagnoses the status of hearing aid 100. This status is sent to light panel 315 through connector 316, and indicator lights 310, 311, 312 and 314 provide messages such as “Power on,” “Cleaning cycle in progress,” “Service hearing aid,” and “Passed test,” as appropriate to the test results.

It should be noted that a program to debug testing and cleaning device 300 could be run without hearing aid 100 in testing and cleaning device 300 to ensure that testing and cleaning device 300 is working properly.

Additionally, testing and cleaning device 300 performs a cleaning process to dissolve earwax and other undesirable buildup from hearing aid 100. The cleaning process may be performed prior to the testing process described above or subsequent to the testing process described above (i.e., as a result of the testing process determining the need for hearing aid 100 to be cleaned), and may further be performed iteratively.

In preparation for the cleaning process, the consumer fills reservoir 331 with an appropriate cleaning solution via inlet shaft 345. To initiate the cleaning process, controller and DSP 330 actuates valve 335 to an open position via connector 336 and initiates pump 333 via connector 334. Cleaning solution is then pumped to cavity 355 via tubing 332 until controller and DSP 330 receives an appropriate signal from sensing element 346 via connector 347 that matches an optimal cleaning solution fill level that is stored in its memory, e.g., a volume of liquid that completely submerges hearing aid 100. Spacers 381 ensure that cleaning solution makes contact with nearly the entirety of the exterior surface of hearing aid 100, including the shaft and canal of hearing aid 100 that house output speaker 105, upon which earwax most heavily accumulates, while optimally positioning hearing aid 100 with respect to microphone 303. Controller and DSP 330 subsequently turns off pump 333 via connector 334 and actuates valve 335 to a closed position via connector 336. Controller and DSP 330 turns heating element 339 on via connector 340. Controller and DSP 330 turns on agitator 337 via connector 338. The turbulent heated cleaning solution effectively removes earwax from hearing aid 100. Upon completion of the cleaning process, controller and DSP 330 turns agitator 337 off via connector 338 and turns heating element 339 off via connector 340. Controller and DSP 330 actuates valve 342 to an open position via connector 343 and the used cleaning solution is drained from cavity 355 via tubing 341. Optional reservoir 344 temporarily stores the used cleaning solution until it is convenient for the user to drain testing and cleaning device 300. Alternately, tubing 341 can lead directly to the exterior of testing and cleaning device 300 and may serve to drain the used cleaning solution from cavity 355 upon the appropriate mechanical actions of the user (e.g., the user removes a small gasket from the bottom of testing and cleaning device 300 or rotates a dial on the exterior of testing and cleaning device 300) or electrical signals from controller and DSP 330 that actuate valve 342 to an open position via connector 343.

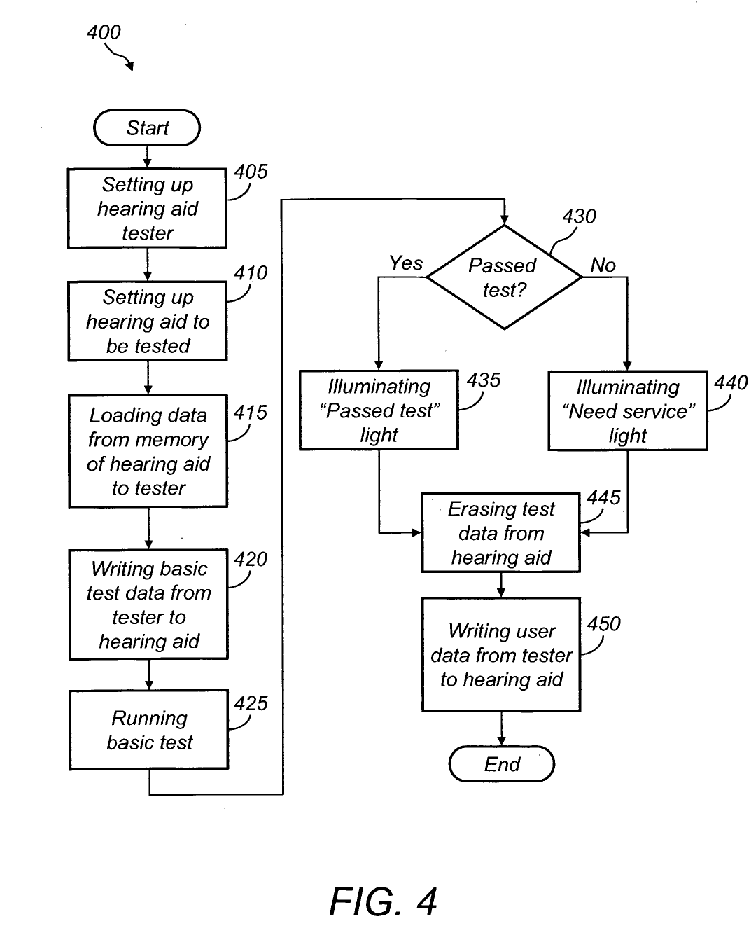

FIG. 4 shows a method 400 of testing hearing aids such as hearing aid 100 of FIG. 1A using at-home routine automatic hearing aid testing and cleaning device 200, where the testing device generates test tones. Alternately, this method could employ testing and cleaning device 300, using the corresponding elements described above. Method 400 includes the steps of:

### Step 405: Setting up Hearing Aid Tester

In this step, testing and cleaning device 200 is turned on. A debug test is run with the unit closed and no hearing aid 100 in the device to ensure that testing and cleaning device 200 is working properly. Top 201 is opened. Additionally, when using the alternate embodiment of the present invention as described in FIG. 3, reservoir 331 is manually filled with cleaning solution in this step. Method 400 proceeds to step 410.

### Step 410: Setting up Hearing Aid to be Tested

In this step, hearing aid 100 is removed from the user's ear, turned on (if not already on), and placed in base 202. Vacuum 208 pulls hearing aid 100 snugly into soundproofing 280 of base 202 to ensure a soundproof environment for output speaker 105 of hearing aid 100 and microphone 203. Top 201 is closed. Method 400 proceeds to step 415.

Step 415: Loading Data from Memory of Hearing Aid to Tester

In this step, testing and cleaning device 200 automatically downloads programming data from memory 107 of hearing aid 100, storing the data in testing and cleaning device 200 to clear memory 107 in preparation for the diagnostic hearing aid test of the present invention. Method 400 proceeds to step 420.

Step 420: Writing Basic Test Data from Tester to Hearing Aid

In this step, microphone 203 rises from its resting position in groove 282 of soundproofing 280 and is positioned in a location such as below output speaker 105 of hearing aid 100 to begin testing hearing aid 100. Basic test data is written from testing and cleaning device 200 to memory 107 in preparation for the diagnostic hearing test. Method 400 proceeds to step 425.

### Step 425: Running Basic Test

In this step, the user initiates the test program, which sends sounds (tones) at various amplitudes directly from controller and DSP 230 of testing and cleaning device 200 to speaker 204. These tones are then received by microphone 101 of hearing aid 100, are output through output speaker 105, then are collected by microphone 203 of testing and cleaning device 200 and conveyed as test results to controller and DSP 230. Method 400 proceeds to step 430.

### Step 430: Passed Test?

In this decision step, the test results are compared with standard hearing aid data stored in testing and cleaning device 200 to determine whether hearing aid 100 is functioning as intended when optimized for the user. This comparison step may be performed by a computer algorithm that compares a test result, such as a given frequency and amplitude, with the expected result and then calculates whether the test result is within tolerance. If hearing aid 100 is functioning within tolerance, method 400 proceeds to step 435; if not, method 400 proceeds to step 440. Method 400 proceeds to step 435.

### Step 435: Illuminating “Passed Test” Light

In this step, controller and DSP 230 sends a signal to light panel 215 to illuminate indicator light 214, which indicates that hearing aid 100 has passed the test. Method 400 proceeds to step 440.

Step 440: Illuminating “Need service” Light

In this step, controller and DSP 230 sends a signal to light panel 215 to illuminate indicator light 210, which indicates that hearing aid 100 needs service. This signals the user to seek professional maintenance of hearing aid 100 and testing and cleaning device 200 once method 400 is complete. The hearing health professional would then assess both hearing aid 100 and testing and cleaning device 200 and perhaps also the user's hearing, recommending remedial action. Method 400 proceeds to step 445.

Step 445: Erasing Test Data from Hearing Aid

In this step, testing and cleaning device 200 erases the test data from memory 107 of hearing aid 100. Method 400 proceeds to step 450.

Step 450: Writing User Data from Tester to Hearing Aid

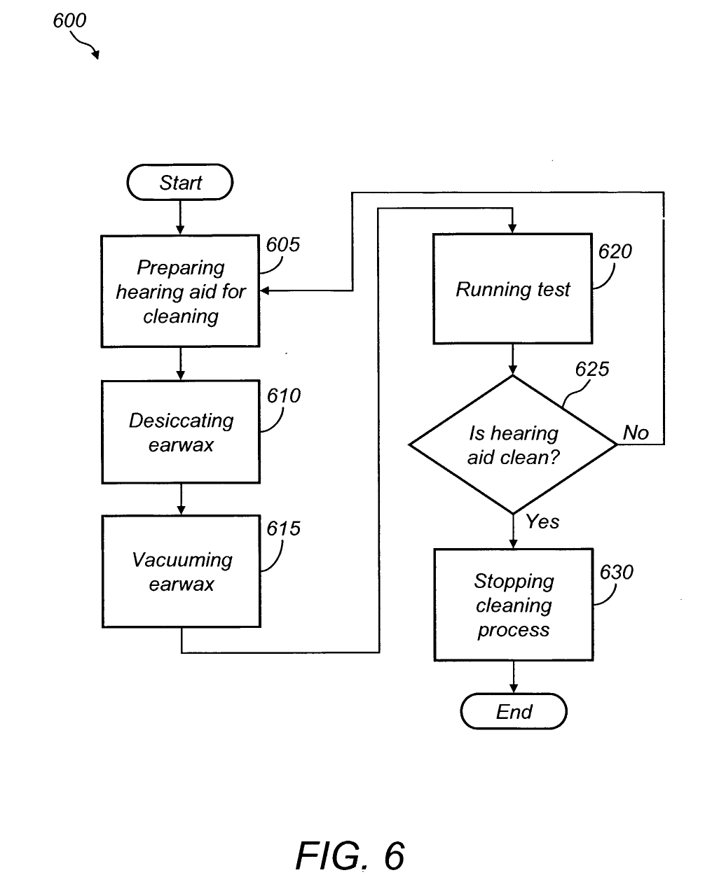

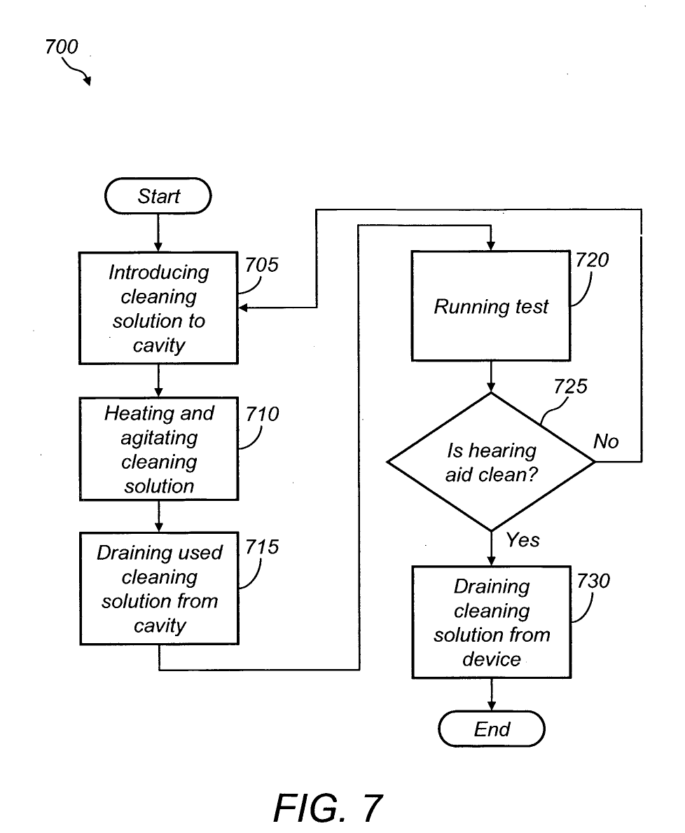

In this step, testing and cleaning device 200 writes the user's programming data that was stored in testing and cleaning device 200 in step 415 back into memory 107 of hearing aid 100. Hearing aid 100 may be removed from testing and cleaning device 200 (or alternate embodiment testing and cleaning device 300) at this point, or may be left in the device for cleaning as described in reference to FIGS. 6 and 7. Method 400 ends.

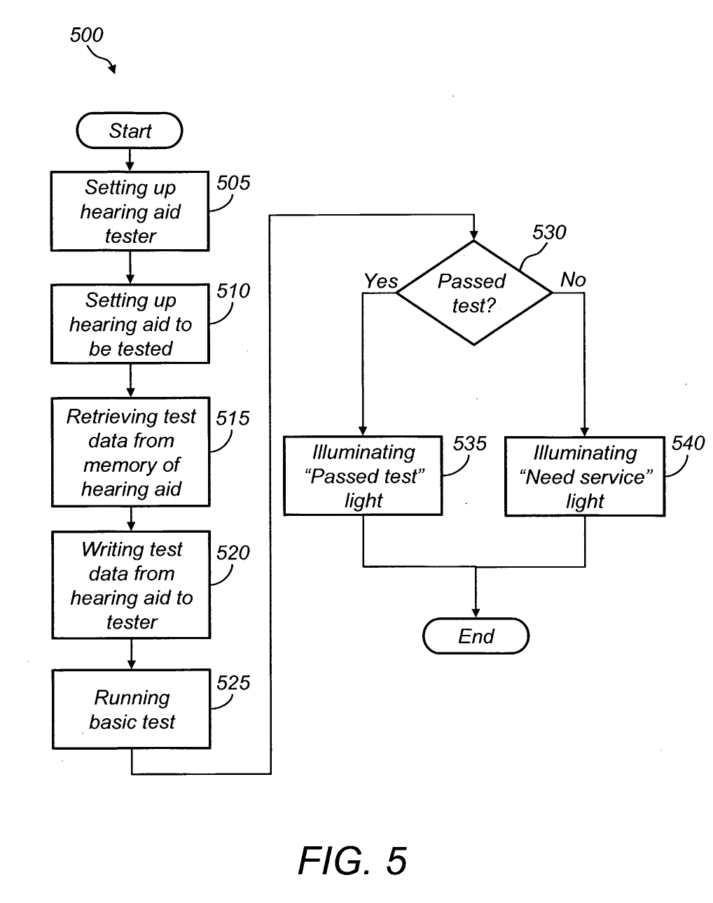

FIG. 5 shows a method 500 of testing hearing aids such as hearing aid 100 of FIG. 1A using at-home routine automatic hearing aid testing and cleaning device 200, where tones are generated by the hearing aid. Alternately, this method could employ testing and cleaning device 300, using the corresponding elements described above. Method 500 includes the steps of:

### Step 505: Setting up Hearing Aid Tester

In this step, testing and cleaning device 200 is turned on. A debug test is run with the unit closed and no hearing aid 100 in the device to ensure that testing and cleaning device 200 is working properly. Top 201 is opened. Additionally, when using the alternate embodiment of the present invention, reservoir 331 is manually filled with cleaning solution in this step. Method 500 proceeds to step 510.

### Step 510: Setting up Hearing Aid to be Tested

In this step, hearing aid 100 is removed from the user's ear, is turned on (if not already on), and is fitted onto base 202. Top 201 is closed. Method 500 proceeds to step 515.

Step 515: Retrieving Test Data from Memory of Hearing Aid

In this step, hearing aid 100 is initialized by controller and DSP 230, which causes hearing aid 100 to automatically generate tones and retrieve other user-personalized programming data from memory 107 in preparation for the diagnostic hearing aid test that has been optimized for the individual user. Method 500 proceeds to step 520.

Step 520: Writing Basic Test Data from Hearing Aid to Tester

In this step, test data retrieved in step 515 is written from memory 107 of hearing aid 100 to testing and cleaning device 200 in preparation for the diagnostic hearing test. Method 500 proceeds to step 525.

### Step 525: Running Basic Test

In this step, the user initiates the test program, or, alternatively, the test program is automatically performed following step 520. The test program sends sounds (tones) at various amplitudes directly from output speaker 105 of hearing aid 100. The sounds are received by microphone 203 of testing and cleaning device 200 and are sent to controller and DSP 230. Method 500 proceeds to step 530.

### Step 530: Passed Test?

In this decision step, the test results are compared with standard hearing aid data stored in testing and cleaning device 200 to determine whether hearing aid 100 is functioning as intended when optimized for the user. This comparison step may be performed by a computer algorithm that compares a test result, such as a given frequency and amplitude, with the expected result, then calculates whether the test result is within tolerance. If hearing aid 100 is functioning within tolerance, method 500 proceeds to step 535; if not, method 500 proceeds to step 540. Method 500 proceeds to step 535.

### Step 535: Illuminating “Passed Test” Light

In this step, controller and DSP 230 sends a signal to light panel 215 to illuminate indicator light 214, which indicates that hearing aid 100 has passed the test. Method 500 proceeds to step 540.

### Step 540: Illuminating “Need Service” Light

In this step, controller and DSP 230 sends a signal to light panel 215 to illuminate indicator light 210, which indicates that hearing aid 100 needs service. This signals the user to seek professional maintenance of hearing aid 100 and testing and cleaning device 200 once method 500 is complete. The hearing health professional would then assess both hearing aid 100 and testing and cleaning device 200, and perhaps also the user's hearing, recommending remedial action. Hearing aid 100 may be removed from testing and cleaning device 200 (or alternate embodiment testing and cleaning device 300) at this point, or may be left in the device for cleaning as described in reference to FIGS. 6 and 7. Method 500 ends.

In an alternative preferred embodiment, a self-test or calibration of the testing and cleaning device 200 is initially performed before step 505. If the device 200 passes the test, then in step 540 the indicator light 210 is illuminated to signal the user to seek professional maintenance of only the hearing aid 100.

FIG. 6 shows a method 600 of cleaning hearing aids such as hearing aid 100 of FIG. 1A using at-home routine automatic hearing aid testing and cleaning device 200. Although the practice of method 600 assumes that hearing aid 100 has been tested, i.e., as described in reference to FIGS. 4 or 5, prior to cleaning, hearing aid 100 may be placed in testing and cleaning device 200 and cleaned without previous testing. Method 600 includes the steps of:

### Step 605: Preparing Hearing Aid for Cleaning

In this step, controller and DSP 230 initiates the cleaning process by lowering microphone 203 into groove 282. Method 600 proceeds to step 610

### Step 610: Desiccating Earwax

In this step, controller and DSP 230 activates heating element 239, fan 238, and vacuum 208. The heat source from heating element 239 desiccates and kills foreign residue, such as earwax and bacteria, on hearing aid 100 by drawing moisture away from the foreign residue. Air moved by fan 238 further helps peel off the dried residue. Heating element 239 emits heat, which is circulated around hearing aid 100 by fan 238. The heat source can be a UV heat source that serves to both kill bacteria on hearing aid 100 as well as take away moisture from any accumulated earwax. Heating element 239 draws moisture from accumulated earwax causing it to become brittle and flake off into particulates. The cleaning cycle continues for an appropriate time interval that is governed by controller and DSP 330. Method 600 continues to step 615.

### Step 615: Vacuuming Earwax

In this step, the dried particulate is sucked away from hearing aid 100 by vacuum 208. Electrical signals from controller and DSP 230 via connector 243 actuate valve 242 to an open position. Particulate is sucked through valve 242 and accumulates in optional reservoir 244, which can later be emptied. Method 600 continues to step 620.

### Step 620: Running Test

In this optional step, controller and DSP 230 runs a diagnostic test, which may have provided from a remote database over a communications network, and determines whether hearing aid 100 is sufficiently clean of earwax and other debris. This step enables iterative cleaning of hearing aid 100. Method 600 proceeds to step 625.

### Step 625: Is Hearing Aid Clean?

In this decision step, controller and DSP 230 determines, based on the test performed in step 620, whether hearing aid 100 is sufficiently clean. If so, method 600 proceeds to step 630. If not, method 600 returns to step 605.

### Step 630: Stopping Cleaning Process

In this step, controller and DSP 230 deactivates heating element 239, fan 238, and vacuum 208 and signals a message to one of indicator lights 210, 211, 212, and 214 in light panel 215, which indicates that the cleaning process is finished. At this point, controller and DSP 230 downloads data regarding battery drain, changes in user profile, and general performance into data storage 251 for future reference. Top 201 is lifted and hearing aid 100 can be taken out of cavity 255. If reservoir 244 is full, the user can empty it of its contents. Method 600 ends.

FIG. 7 shows a method 700 of cleaning hearing aids such as hearing aid 100 of FIG. 1A using at-home routine automatic hearing aid testing and cleaning device 300. Although the practice of method 700 assumes that hearing aid 100 has been tested, i.e., as described in reference to FIGS. 4 or 5, prior to cleaning, hearing aid 100 may be placed in testing and cleaning device 300 and cleaned without previous testing. Method 700 includes the steps of:

### Step 705: Introducing Cleaning Solution to Cavity

In this step, if reservoir 331 has not previously been manually filled with cleaning solution, it is filled now. Controller and DSP 330 initiates the cleaning process by actuating valve 335 to an open position and turning on pump 333, thereby introducing cleaning solution from reservoir 331 to cavity 355 via tubing 332. Cleaning solution continues to flow into cavity 335 via tubing 332 until a signal is received by controller and DSP 330 from sensing element 346 indicating that hearing aid 100 is appropriately submerged, at which time controller and DSP 330 turns pump 333 off and actuates valve 325 to a closed position. Method 700 proceeds to step 710.

In a preferred embodiment, the device 300 includes a selectively movable lid (not shown) which is positioned to cover the microphone 303 before fluid is introduced into cavity 355 in step 705.

### Step 710: Heating and Agitating Cleaning Solution

In this step, controller and DSP 330 turns on heating element 339 and agitator 337. The action of the heated and agitated cleaning solution dissolves the earwax and removes it from hearing aid 100. The cleaning cycle continues for an appropriate time interval that is governed by controller and DSP 330. Method 700 continues to step 715.

Step 715: Draining Used Cleaning Solution from Cavity

In this step, controller and DSP 330 turns off heating element 339 and agitator 337. Controller and DSP 330 subsequently actuates valve 342 to an open position and used cleaning solution is drained from cavity 355 into reservoir 344. Method 700 continues to step 720.

### Step 720: Running Test

In this optional step, controller and DSP 330 runs a diagnostic test or remotely determines whether hearing aid 100 is sufficiently clean of earwax and other debris. This step enables iterative cleaning of hearing aid 100. Method 700 proceeds to step 725.

### Step 725: Is Hearing Aid Clean?

In this decision step, controller and DSP 330 determines, based on the test performed in step 720, whether hearing aid 100 is sufficiently clean. If so, method 700 proceeds to step 730. If not, method 700 returns to step 705. At this point or in any stage of the testing and cleansing process, controller and DSP 330 can also download data regarding battery drain, changes in user profile, and general performance for future reference. Method 700 proceeds to step 730.

### Step 730: Draining Cleaning Solution

In this step, controller and DSP 230 signals a message to one of indicator lights 310, 311, 312, and 314 in light panel 315, which indicates that the cleaning process is finished. Top 301 is lifted open and hearing aid 100 is removed for use. The user can empty optional reservoir 344 by draining the cleaning solution from testing and cleaning device 300, e.g., by removing a small gasket from the bottom of testing and cleaning device 300 or by rotating a dial on the exterior of testing and cleaning device 300 that allows the passage of used cleaning solution out of the device. Method 700 ends.

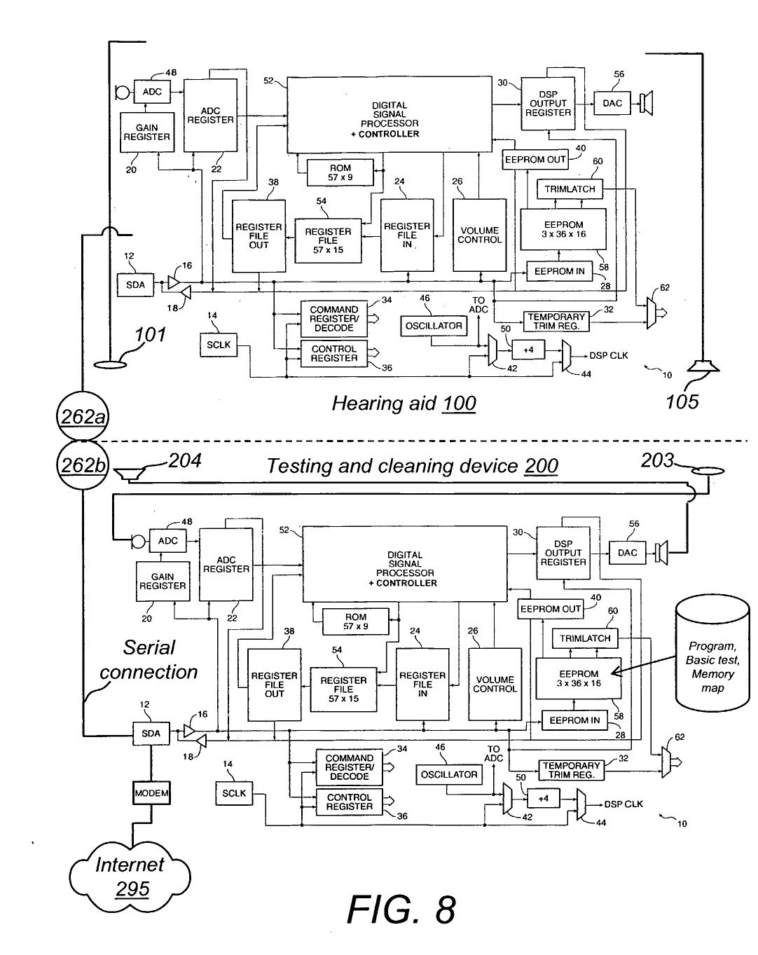

FIG. 8 is a block diagram showing the portions of hearing aid 10 (e.g., basic hearing aid 100 of FIG. 1A) including the serial interface, as explained as FIG. 1B. FIG. 8 shows the physical arrangement of hearing aid 100 (the top section of the diagram) and testing and cleaning device 200 (the bottom section of the diagram). In addition, FIG. 8 shows a physical connection for diagnostic testing data interchange between serial connector 262a of hearing aid 100 and serial connector 262b of testing and cleaning device 200. The program, basic test, and memory map are stored in EEPROM 58 of testing and cleaning device 200.

Microphone 101 of hearing aid 100 is shown opposite speaker 204 of testing and cleaning device 200. Microphone 203 of testing and cleaning device 200 is shown opposite output speaker 105 of hearing aid 100. Serial connectors 262a and 262b are physically connected.

In this manner, an at-home diagnostic hearing aid testing and maintenance process can be performed. The diagnostic test is automatic and convenient, and can be conducted as frequently as daily. The diagnostic test provides updates on the status of the hearing aid status, such as “improper functioning” or “service required,” and may be used to determine whether it is necessary to initiate the cleaning process.

What is claimed is:

1. A portable hearing aid testing apparatus comprising:
a resealable housing defining a cavity for receiving a hearing aid, wherein the cavity comprises a microphone and has a configuration for securing the hearing aid in a position where a speaker of the hearing aid is situated opposite of the microphone;
means for cleaning the hearing aid when the hearing aid is received within the cavity and the housing is in a sealed condition;
a communications interface means for coupling to a data signal connection means of the hearing aid; and
a controller coupled to the communications interface means, the microphone and an indicia output means, wherein the controller is operable for at least one of a cleaning and a testing of the operation of the hearing aid.

2. The apparatus of claim 1, wherein the means for cleaning comprises at least one of a means for filling and emptying the cavity with a cleaning fluid, a means for heating the cavity, a means for heating the cleaning fluid, and a means for agitating the fluid when the fluid is in the cavity.

3. The apparatus of claim 1, wherein the indicia output means is an indicator light.

4. The apparatus of claim 1, which further comprises a layer of material having low heat energy absorption characteristics on exposed surfaces.

5. The apparatus of claim 1, which further comprises soundproofing materials on the inner and outer surfaces.

6. The apparatus of claim 1, which further comprises a selectively movable lid which is positioned to cover the microphone before a cleaning fluid is introduced into the cavity.

7. A method for testing the operation of a hearing aid, said method comprises:
transmitting testing data from a controller to cause the hearing aid to generate a sound output;
receiving the sound output at a microphone;
forwarding sound data signals representative of the sound output to the controller;
evaluating the sound data signals to determine whether frequencies and amplitudes of the sound signals correspond to expected frequencies and amplitudes associated with the testing data; and
generating a selected indicia for output at an indicia output means.

8. The method of claim 3, wherein the data is transmitted to the hearing aid or to a speaker within a cavity of a resealable housing.

9. The method of claim 3, wherein the selected indicia for output is a pass or fail of a clean hearing aid.

10. A method for testing the operation of a hearing aid, said method comprises:
downloading hearing aid programming from the hearing aid to a controller;
writing testing data to a memory in the hearing aid;
causing a sound output to be generated at an external speaker output of a portable hearing aid testing apparatus of claim 1;
receiving the sound output at a microphone resulting from operation of the testing data;
forwarding sound data signals representative of the sound output to a controller;
evaluating the sound data signals to determine whether frequencies and amplitudes of the sound signals correspond to expected frequencies and amplitudes associated with the testing data; and
generating a selected indicia for output at an indicia output means.

11. The method of claim 10, which further comprises calibrating or self-testing of the apparatus before downloading hearing aid programming from the hearing aid to the controller.

12. The method of claim 7, wherein the selected indicia for output is a pass or fail of a clean hearing aid.

13. The method of claim 7, wherein the testing data is user customized testing data.
